(19) United States
(12) Patent Application Publication
(10) Pub. No.: US 2017/0295727 A1
(43) Pub. Date: Oct. 19, 2017

(54) TEMPORALLY MODULATED LIGHTING SYSTEM AND METHOD

(71) Applicant: Suntracker Technologies Ltd., Victoria (CA)

(72) Inventors: Ian Edward Ashdown, West Vancouver (CA); Wallace Jay Scott, Victoria (CA)

(21) Appl. No.: 15/491,166

(22) Filed: Apr. 19, 2017

Related U.S. Application Data
(60) Provisional application No. 62/324,404, filed on Apr. 19, 2016.

(51) Int. Cl. A01G 7/04; A01G 1/00; A01K 63/06; H05B 37/02

(52) U.S. Cl. CPC A01G 7/045; H05B 37/0227; A01G 1/001; A01K 63/06

(57) ABSTRACT

Electric light sources typically exhibit temporal variations in luminous flux output, commonly referred to as “flicker.” Flicker, or temporal modulation, is known to influence the growth, health and behavior patterns of humans, and is also linked to growth, health and behavior patterns throughout the growth cycle of plants and animals. Control of peak radiant flux emitted by a light source to temporally modulate a light source will allow for the control of plants and animals for sustainable farming including but not limited to horticultural, agricultural, or aquacultural endeavors.

This application claims benefit of U.S. provisional Ser. No. 62/324,404 filed 19 Apr. 2016, which is incorporated by reference herein in its entirety.

### TECHNICAL FIELD

The subject matter of the present invention relates to the field of biological lighting systems and more particularly, is concerned with the beneficial aspects of electric light source flicker for plants and animals for sustainable farming, including but not limited to horticultural, agricultural, and aquacultural endeavors.

### BACKGROUND

Electric light sources powered by alternating current power sources typically exhibit temporal variations in luminous flux output, commonly referred to as “flicker.” Depending on the alternating current frequency, the ratio or maximum to minimum luminous flux output, and the modulation waveform, flicker may be perceived as being a moderately to severely annoying visual artifacts that needs to be alleviated or eliminated.

Vision research to date, however, has mostly focused on the human aspects of visual flicker. Light sources with rapid temporal variations do not occur in nature, and so both animals and plants may exhibit physiological and psychological responses to flickering electric light sources that may be detrimental or beneficial.

Animal husbandry and horticulture in particular are two fields where such physiological and psychological responses may impact the health and wellbeing of the animals and plants, and thereby engender economic benefits and risks. The present invention therefore seeks to address these issues with a system and method for controlling flicker.

### SUMMARY

A method for temporally modulating a light source for plants wherein the peak radiant flux emitted by a light source can be temporally modulated according to a plant's photopigments and cellular mechanisms to control the response by the plant to electric light source flicker.

A system for temporally modulating a light source for plants wherein: at least one response variable is monitored and the resultant signal incorporated in a closed loop feedback system; and the parameters of the temporally modulated lighting system adjusted.

### BRIEF DESCRIPTION OF DRAWINGS

FIG. 1 shows the measured temporal contrast sensitivity function of the human visual system.

FIG. 2 shows four example pulse width modulation waveforms that exhibit different duty cycles but result in constant average radiant flux.

FIG. 3 shows a flowchart for a closed loop feedback system capable of maintaining optimal plant growth.

FIG. 4 shows a trainable neural network controller that learns optimal settings for temporally modulated light sources.

### DETAILED DESCRIPTION

The present invention is herein described more fully with reference to the accompanying drawings, in which embodiments of the invention are shown. This invention may, however, be embodied in many different forms, and should not be construed as limited to the embodiments described herein. Rather, these embodiments are provided so that this disclosure will be thorough and complete, and will fully convey the scope of the invention to those skilled in the art.

For the purposes of this application, sustainable farming is the production of food, fiber, or other plant or animal products using techniques that aim to protect the environment, public health, human communities, and animal welfare. Sustainable farming includes but is not limited to horticultural, agricultural, and aquacultural endeavors, including animal husbandry. Any reference to sustainable farming includes one or more, or collectively all, of these endeavors.

The perception of electric light flicker by the human visual system has been studied for more than a century (e.g., Greene 2013). It is widely known that human sensitivity to flicker increases with increasing frequency from one or two Hertz up to approximately 20 to 30 Hertz, depending on the level retinal illuminance, then decreases rapidly for higher frequencies. It is also known that in humans peripheral vision is more sensitive than central vision to flicker.

The “critical fusion frequency” (CFF) is defined as the frequency at which a flashing light source is perceived as a steady rather than an intermittent visual stimulus. This frequency varies with stimulus size, shape, retinal location, adaptation luminance, and modulation depth, but rarely exceeds 60 Hertz, even with a large visual area with 100 percent modulation, seen with a high adaptation luminance.

Flicker above the CFF can be indirectly perceived as blur in the case of high-speed motion, either with perceived objects or rapid eye movement. Stroboscopes in particular take advantage of this psychophysiological phenomenon to render quickly rotating objects as appearing to be static or slowly rotating. Bullough et al. (2013) have shown that the stroboscopic effects of light source flicker are detectable for frequencies as high as one kilohertz.

Even when not visually noticeable, flicker has been implicated in adverse health effects, including headaches, fatigue, blurred vision, eyestrain, migraines, reduced visual task performance, as well as increases in autistic behaviors in children and neurological problems, including epileptic seizures.

With the introduction of semiconductor light-emitting diodes for general lighting applications, the effects of visual flicker on both perception and health and wellbeing has recently become of increased concern to lighting designers (e.g., IEEE 2015. Perrin et al. 2016).

Compared to human perception of visual flicker, less research has been conducted on the perception of flicker by animals (e.g., Boström et al. 2016, Healy et al. 2013, Inger et al. 2014, Lisney et al. 2012).

The animal research has focused on measuring the CFF of various species (e.g., Inger et al. 2014), but there does not appear to be any research on the long-term psychological and physiological impacts of flicker on domestic animals kept under constant electric lighting, even though it is acknowledged as a possibility by, for example, Lisney et al. (2012) in relation to fluorescent lighting.

As for plants, Lefsrud and Kopsall (2006) consider only time periods of hours to minutes for on-off cycles of horticultural lighting.

For animals, sensitivity to light is mediated by light-sensitive proteins called “opsins.” More than one thousand opsins have been identified to date, and occur in not only animals, but also archaea, bacteria, fungi, and certain algae (Terakita 2005). In humans, at least five opsins—rhodopsin, long-, medium-, and short-wave opsins, melanopsin, and neuropsin—are responsible for both visual and non-visual light and ultraviolet radiation sensitivity. A complex series of photochemical reactions and neural responses mediate our psychophysiological responses to varying light conditions, with response times ranging from picoseconds to minutes. While there are many different opsins present in the light-sensitive organs of other animal species, they all perform similar functions.

For plants, various photopigments are sensitive to light, including chlorophyll A and B (responsible for photosynthesis), phytochrome (responsible for plant photomorphogenesis), cryptochromes, and many different cartenoids, including xanthophylls and carotenes, that both assist in photosynthesis and protect chlorophyll from damage by ultraviolet radiation and blue light.

Phytochrome in particular has two isoforms, designated Pᵣ and P_{fr}, that function as a photosensitive switch when alternately to red (˜625 nm) and far red (˜730 nm) electromagnetic radiation. This switch regulates a wide variety of physiological functions in plants, including seed germination, shoot growth, flowering, leaf expansion and abscission, and bud dormancy. Borthwick et al. (1952) demonstrated that light pulses as short as one minute are sufficient to disrupt these functions, thereby influencing plant growth. There are at least 600 known cartenoids, and it is not known whether any of them similarly function as photosensitive switches. It is also not known whether there is an upper limit to the exposure frequency for phytochrome in vivo, and the effect this may have on plant development. Effects may range from obvious changes in plant morphology to temporal changes in plant development and the production of plant biomass, nutrients, aromatics, or desirable pharmaceutical compounds.

Plants have also evolved various strategies for dissipating the excess energy received from sunlight. Miller et al. (2001), for example, discuss non-photochemical mechanisms whereby chlorophyll molecules dissipate excess excitation energy as heat.

Plant photopigments and cellular mechanisms will respond in various ways to electric light source flicker, with modulation frequencies potentially ranging from tens of seconds to megahertz. As one example, a plant species irradiated with electromagnetic radiation with a modulation frequency of one to ten kilohertz and a small pulse width duty factor may respond differently over its growth cycle compared to the same species irradiated with constant radiation, even though the irradiance and spectral power distribution may be the same.

Plant biologists and horticulturalists have observed that different plant species respond differently to the same lighting conditions. Given this, determining the responses of the many different plant species to temporally modulated electromagnetic radiation may require additional experimentation. Nevertheless, the basic principles of a novel lighting system can be disclosed that take advantage of these responses.

In one embodiment, the peak radiant flux emitted by a light source can be temporally modulated. For example, the peak drive current delivered to a semiconductor light-emitting diode may be controlled by analog circuitry. Alternatively, the drive current may be digitally modulated at a high frequency that does not influence the plant response.

The average radiant flux emitted by a light source can additionally be temporally modulated. For example, the duty cycle of a pulse width modulation current delivered to a semiconductor light-emitting diode may be controlled by digital circuitry. With 100 percent duty cycle, the light source will deliver constant irradiance for the plant at a level that it can tolerate. Conversely, with say 20 percent duty cycle and 5 times the peak level, the light source will deliver the same average irradiance, but with peak irradiance such that the plant is forced to dissipate the excess energy received during each pulse.

The waveform of the temporally modulated flux may be an on-off square wave with a variable duty factor. A more complex waveform may also be employed.

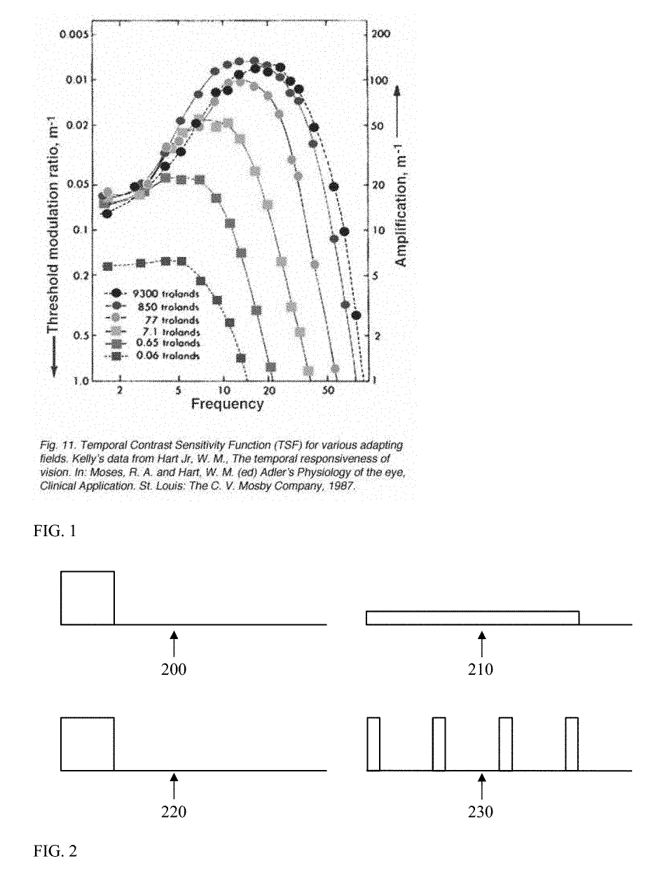

FIG. 2 shows four examples of pulse width modulation (PWM) waveforms that exhibit different duty cycles but result in constant average radiant flux.

In one embodiment, the peak radiant flux can be controlled by an analog constant current driver while the average radiant flux is controlled by an additional digital constant current driver. As an example, 200 shows a pulse width modulated (PWM) waveform with a 20 percent duty factor, while 210 shows a PWM waveform with 80 percent duty factor and a peak output that is 25 percent of that shown in 200. Consequently, both waveforms result in the same average radiant flux.

In another embodiment, the peak radiant flux can be controlled by a high-frequency digital constant current driver while the average radiant flux is controlled by an additional digital constant current driver with a lower frequency signal that is superimposed on the high frequency signal. (As an example, 220 shows a pulse width modulated (PWM) waveform with a 20 percent duty factor, while 230 shows a PWM waveform with four evenly-spaced pulses, each exhibiting 5 percent duty factors and the same peak output as that shown in 220. Consequently, both waveforms again result in the same average radiant flux.)

In a preferred embodiment, only selected regions of the electromagnetic radiation spectrum are temporally modulated. Many plant photopigments have narrow spectral responsivity bandwidths, and so it is advantageous to provide temporally modulated irradiance within these spectral bands while otherwise providing constant irradiance across the biologically active spectrum. Similarly, it is advantageous to modulate different bands with different frequencies, and with different peak and average radiant flux.

Changes in modulation over the growth cycle of a plant species may also be implemented to take into account the changes in plants physiology during the plant growth cycle, including plant photopigments. This results in a need to modify the regions of the electromagnetic radiation spectrum as a plant matures. Plant maturity may include the stages from germination to seedling, to young plant, to mature plant. Similar changes in modulation as animals or fish mature may also be implemented to take into account the changes in animal physiology and behavior during growth.

In another embodiment the temporal modulation frequency or frequencies, peak and average radiant fluxes, and spectral power distribution are varied on a diurnal day-night basis (which is not necessarily 24 hours in length), and over the growth cycle of the species being grown under the lighting conditions.

In another embodiment the temporally modulated electric lighting is combined with constant electric lighting.

The temporally modulated electric lighting may be combined with natural daylight.

The temporally modulated electric lighting may be combined with natural daylight and supplemental electric lighting.

The temporally modulated electric lighting may be combined with natural daylight or natural daylight and supplemental electric lighting through a daylight harvesting system. A daylight harvesting system may include a combination of hardware and software used to maximize the effectiveness and/or efficiency of electric lighting in conjunction with natural daylight.

Temporally modulated lighting may be provided by variable transmittance windows, such as for example electrochromic windows or a system of automated blinds and louvers.

In one embodiment one or more response variables is monitored and the resultant signal incorporated in a closed loop feedback system, wherein the parameters of the temporally modulated lighting system may be adjusted to optimize system performance. As an example, the chlorophyll fluorescence of a plant may be monitored as an indication of plant health, and the pulse width modulation frequency or duty cycle adjusted using a proportional-integral-derivative (PID) control algorithm to maintain plant health.

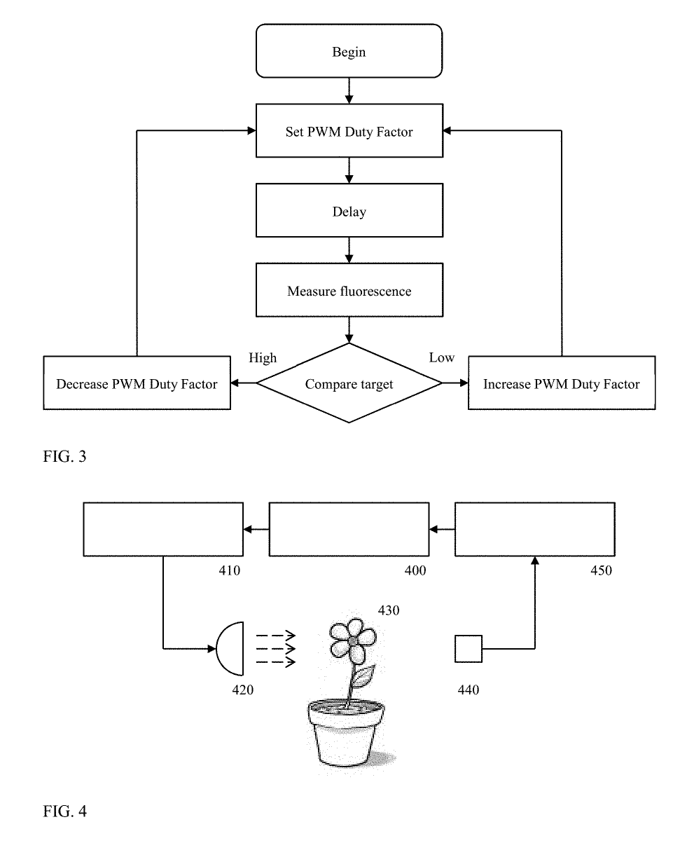

As an example, FIG. 3 shows a flowchart for a closed loop feedback system wherein the PWM duty factor is periodically adjusted such that the measured chlorophyll fluorescence of a plant is maintained within desired limits during plant growth.

One or more response variables may be monitored and the resultant signal incorporated in a fuzzy logic or neural network control system with artificial intelligence capabilities that can learn optimum combinations of system parameter settings for different plant species and predict optimal settings based on observed temporal trends in system performance.

As an example, FIG. 4 shows a trainable neural network controller 400 that sets the peak amplitude and duty cycle of light source controller 410, which provides temporally modulated drive current to light source 420. Light source 420 irradiates plant 430 with biologically active radiation, causing the plant to grow. Sensor 440 detects a plant growth and health parameter, such as for example chlorophyll fluorescence or fruit color. Sensor controller 450 periodically samples the signal from sensor 440 and provides the data as input to neural network controller 400.

Any one or more response variables monitored, and any input data, may be collected as data and stored in a database locally, transmitted, including wireless transmission, to an offsite database, or stored or transmitted in a means that will allow import into a database. The availability and accessibility of this data may allow for further refinements within the system, and additional study of the results.

While this disclosure discusses temporally modulated lighting in terms of plant growth in greenhouses and vertical farms, the invention may also be applied to animal husbandry applications, included but not limited to aviaries, poultry farms, aquaculture farms, fresh and saltwater aquaria, and insects raised for protein (food), pest control, and pharmaceutical purposes.

We claim:

1. A method for temporally modulating a light source for sustainable farming wherein the peak radiant flux emitted by a light source is temporally modulated to control the response to electric light source flicker.

2. A method of claim 1 wherein the light source is used for horticulture, wherein the peak radiant flux emitted by a light source is temporally modulated according to a plant's photopigments and cellular mechanisms to control the response by the plant to electric light source flicker.

3. A method of claim 2 whereby only selected regions of the electromagnetic radiation spectrum are temporally modulated.

4. A method of claim 3 whereby changes to the temporal modulation are made to selected regions of the electromagnetic radiation spectrum through the growth cycle of the plant.

5. A method of claim 2 wherein the temporally modulated electric lighting is combined with constant electric lighting.

6. A method of claim 2 wherein the temporally modulated electric lighting is combined with natural daylight.

7. A method of claim 2 wherein the temporally modulated electric lighting is combined with natural daylight and supplemental electric lighting.

8. A method of claim 2 where temporally modulated lighting is provided by variable transmittance windows.

9. A system for temporally modulating a light source for horticulture wherein:
one or more response variable is monitored and the resultant signal incorporated in a closed loop feedback system; and
the parameters of the temporally modulated lighting system adjusted.

10. A system of claim 9 wherein one or more response variables and adjustments made are recorded for export to a database.

11. A system of claim 9 wherein at least one response variable is monitored and the resultant signal incorporated in a fuzzy logic or neural network control system with artificial intelligence capabilities.
